(19) United States
(12) Patent Application Publication
(10) Pub. No.: US 2016/0055763 A1
(43) Pub. Date: Feb. 25, 2016

(54) ELECTRONIC APPARATUS, PRONUNCIATION LEARNING SUPPORT METHOD, AND PROGRAM STORAGE MEDIUM

(71) Applicant: CASIO COMPUTER CO., LTD., Tokyo (JP)

(72) Inventor: Kazuhisa NAKAMURA, Akiruno-shi (JP)

(73) Assignee: CASIO COMPUTER CO., LTD., Tokyo (JP)

(21) Appl. No.: 14/832,823

(22) Filed: Aug. 21, 2015

(30) Foreign Application Priority Data
Aug. 25, 2014 (JP) 2014-170765

(51) Int. Cl. G09B 19/06; G09B 5/06

(52) U.S. Cl. CPC G09B 19/06; G09B 5/06

(57) ABSTRACT

According to one embodiment, an electronic apparatus includes a display and a processor. The processor executes a process of displaying on the display a word which a user is prompted to pronounce; acquiring speech which the user uttered by pronouncing the displayed word; and analyzing a pronunciation of the acquired speech, determining a part of the word, with respect to which a pronunciation relating to the word is incorrect, acquiring, as a word for practice, word which includes the part of the incorrect pronunciation and is shorter than the displayed word, and displaying on the display the word which is acquired as the word for practice.

### CROSS-REFERENCE TO RELATED APPLICATIONS

This application is based upon and claims the benefit of priority from Japanese Patent Application No. 2014-170765, filed Aug. 25, 2014, the entire contents of which are incorporated herein by reference.

### BACKGROUND OF THE INVENTION

1. Field of the Invention

The present invention relates to an electronic apparatus which is suited to learning, for example, the pronunciation of a foreign language, and a pronunciation learning support method (and a storage medium storing a control program thereof).

2. Description of the Related Art

Conventionally, in order to learn a foreign language and to become able to speak the foreign language, it is important to master pronunciation as well as reading and writing. Various learning support apparatuses, as will be described below, have been utilized.

A pronunciation learning support apparatus has been thought, wherein with respect to a word that is an object of learning, which was selected by a user, user speech data, which was pronounced by the user and recorded, is compared with prestored model speech data, and a result of this comparative evaluation is displayed as a score (see, e.g. Jpn. Pat. Appln. KOKAI Publication No. 2008-083446).

A foreign language learning apparatus has been thought, which displays, with respect to a foreign language that is an object of learning, a screen for practice including character strings of the foreign language, phonetic symbols and pronunciation video in accordance with the speed of pronunciation which was designated by a user, and also outputs associated speech signals (see, e.g. Jpn. Pat. Appln. KOKAI Publication No. 2004-325905).

In the above-described conventional learning support apparatuses, the pronunciation of a phrase (word) itself of a foreign language that is an object of learning is repeatedly practiced, and skill in pronunciation is improved. However, there is a demand for more efficient and effective practice.

The present invention has been made in consideration of the above problem, and the object of the invention is to provide an electronic apparatus and a pronunciation learning support method (and a storage medium storing a control program thereof), which enable more efficient and effective practice of pronunciation of words.

### BRIEF SUMMARY OF THE INVENTION

In general, according to one embodiment, an electronic apparatus includes a display and a processor. The processor executes a process of displaying on the display a word which a user is prompted to pronounce; acquiring speech which the user uttered by pronouncing the displayed word; and analyzing a pronunciation of the acquired speech, determining a part of the word, with respect to which a pronunciation relating to the word is incorrect, acquiring, as a word for practice, a word which includes the part of the incorrect pronunciation and is shorter than the displayed word, and displaying on the display the word which is acquired as the word for practice.

According to the present invention, the pronunciation of words can more efficiently and effectively be practiced.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating a configuration of an electronic circuit of a pronunciation learning support apparatus 10 according to an embodiment of the present invention.

FIG. 2 is a perspective view illustrating an external-appearance configuration in a case where the pronunciation learning support apparatus 10 is implemented by a tablet terminal 20T and a server apparatus 30S.

FIG. 3 is a front view illustrating an external-appearance configuration in a case where the pronunciation learning support apparatus 10 is implemented by an electronic dictionary apparatus 10D.

FIG. 4 is a view illustrating the content of a word-for-practice search table 32d in a data processing device 30 of the pronunciation learning support apparatus 10.

FIG. 5 is a flowchart illustrating a pronunciation practice process (1) of the first embodiment by the pronunciation learning support apparatus 10.

FIG. 6 is a view illustrating a display operation corresponding to a user operation according to the pronunciation practice process (1) of the first embodiment of the pronunciation learning support apparatus 10.

FIG. 7 is a view illustrating the content of a word-for-practice search table 32d′ of a second embodiment in the data processing device 30 of the pronunciation learning support apparatus 10, and a search procedure, based on the table 32d′, of searching for an important word for practice.

FIG. 8 is a flowchart illustrating a pronunciation practice process (2) of the second embodiment by the pronunciation learning support apparatus 10.

FIG. 9 is a view illustrating a display operation corresponding to a user operation according to the pronunciation practice process (2) of the second embodiment of the pronunciation learning support apparatus 10.

### DETAILED DESCRIPTION OF THE INVENTION

Embodiments of the invention will be described hereinafter with reference to the accompanying drawings.

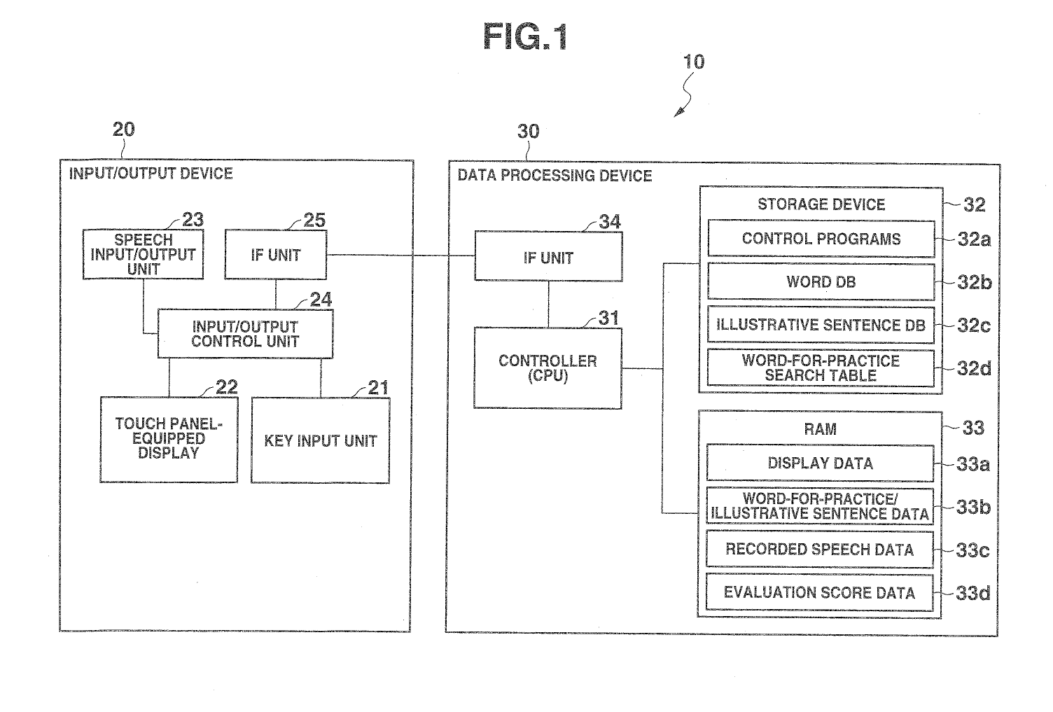

FIG. 1 is a block diagram illustrating a configuration of an electronic circuit of a pronunciation learning support apparatus 10 according to an embodiment of the present invention.

This pronunciation learning support apparatus 10 is configured to include an input/output device 20 and a data processing device 30 which is a computer.

The input/output device 20 includes a key input unit 21; a touch panel-equipped display 22; a speech (voice) input/output unit 23; an input/output control unit 24 for the key input unit 21, touch panel-equipped display 22 and speech input/output unit 23; and an interface (IF) unit 25 for connecting the input/output control unit 24 to the data processing device 30.

The data processing device 30 includes a controller (CPU) 31; a storage device 32 which stores various programs, which control the control operation of the controller 31, and databases; a RAM 33 which stores working data which is involved in the control operation; and an interface (IF) unit 34 for connecting the controller (CPU) 31 to the input/output device 20.

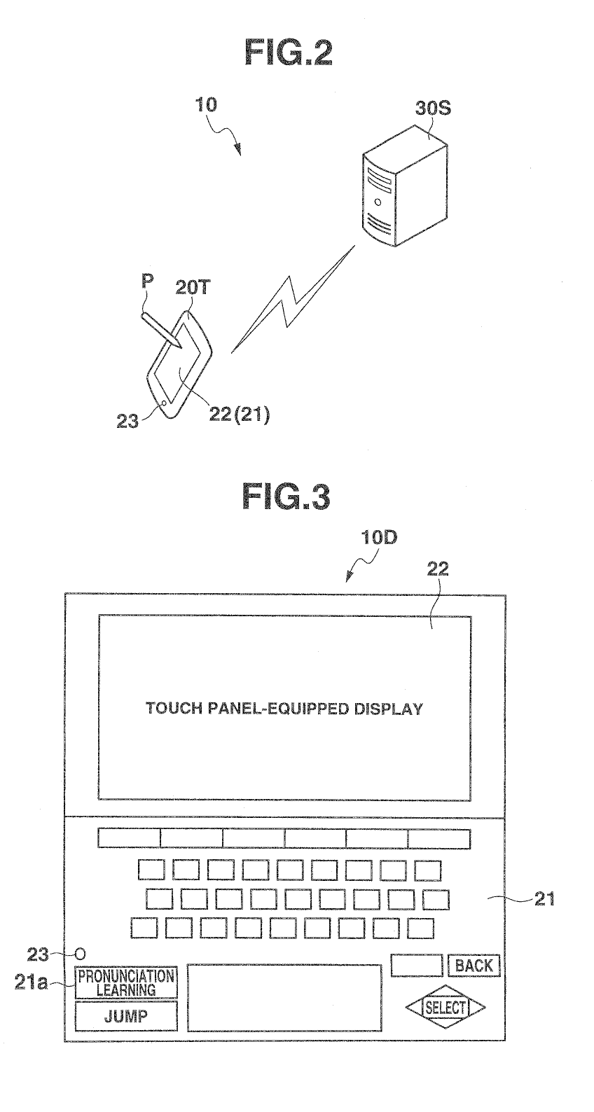

FIG. 2 is a perspective view illustrating an external-appearance configuration in a case where the pronunciation learning support apparatus 10 is implemented by a tablet terminal 20T and a server apparatus 30S.

In the case of the pronunciation learning support apparatus 10 illustrated in FIG. 2, the tablet terminal 20T functions as the input/output device 20, and the server apparatus 30S functions as the data processing device 30.

FIG. 3 is a front view illustrating an external-appearance configuration in a case where the pronunciation learning support apparatus 10 is implemented by an electronic dictionary apparatus 10D.

In the case of the electronic dictionary apparatus 10D illustrated in FIG. 3, both the input/output device 20 and the data processing device 30 are integrally built in the electronic dictionary apparatus 10D. The key input unit 21 and speech (voice) input/output unit 23 are provided on a lower section side of the apparatus body which is opened/closed. The touch panel-equipped display 22 is provided on an upper section side. The key input unit 21 of the electronic dictionary apparatus 10D includes various dictionary designation keys, character input keys, a [Jump] key, an [Select] key, a [Back] key, and a [Pronunciation learning] key 21a for setting an operation mode for pronunciation practice.

In the storage device 32 of the data processing device 30, control programs 32a which are executed by the controller 31, a word DB 32b, an illustrative sentence DB 32c and a word-for-practice search table 32d are prestored, or are stored by being read in from an external storage medium such as a CD-ROM or a memory card, or are stored by being downloaded from a program server on a communication network such as the Internet.

As the control programs 32a, a system program or controlling the overall operation of the pronunciation learning support apparatus 10 and a communication program for data communication with an external device on the communication network or a user PC (Personal Computer) (not shown) are stored. In addition, as the control program 32a, a dictionary search program is stored for controlling the entirety of search/read/display processes based on the databases (DB 32b, 32c) of dictionaries, etc. in the storage device 32, such as a search word input process, an entry word search process corresponding to a search word, and a read/display process of explanatory information corresponding to the searched entry word.

Furthermore, as the control program 32a, a pronunciation learning support program is stored for recording speech data which a user uttered with respect to a word or an illustrative sentence of an object of learning, which was selected from the word database 32b or illustrative sentence database 32c; determining a degree of similarity and an evaluation score by comparing this user speech data and model speech data on a phonetic-symbol-by-phonetic-symbol basis; searching and acquiring, from the word-for-practice search table 32d, a word for practice of a short character string having a phonetic symbol of a speech part with respect to which the evaluation score is lowest and is a specified point or less; and repeatedly executing pronunciation practice with this short word for practice, thereby enabling efficient and effective learning of a part of pronunciation which the user is not good at.

The control program 32a is started in response to an input signal corresponding to a user operation from the key input unit 21 of the input/output device 20 or the touch panel-equipped display 22, or in response to a user speech signal which is input from the speech (voice) input/output unit 23, or in response to a communication signal with an external device on the communication network.

In the word database 32b, text (character string) data of each of words that are objects of learning of pronunciation, phonetic symbol data, translation equivalent data and model speech data are mutually associated and stored.

In the illustrative sentence database 32c, for example, with respect to each of the words stored in the word database 32b, text data of an illustrative sentence using the word, phonetic symbol data, translation equivalent data and model speech data are mutually associated and stored.

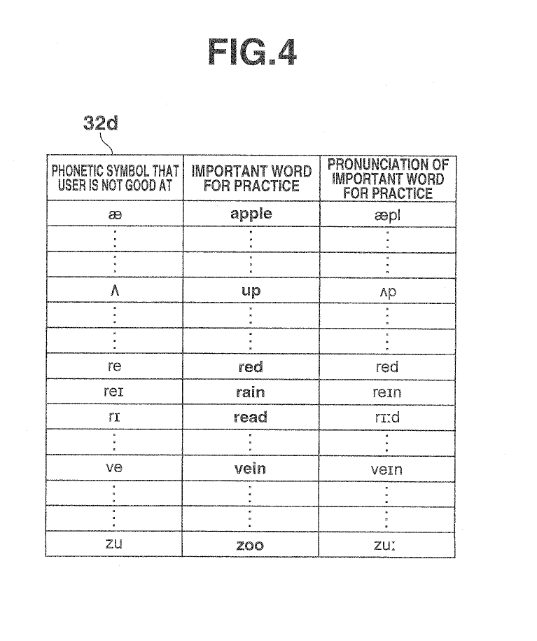

FIG. 4 is a view illustrating the content of the word-for-practice search table 32d in the data processing device 30 of the pronunciation learning support apparatus 10.

In the word-for-practice search table 32d, with respect to each of various phonetic symbols, a word including a pronunciation of the phonetic symbol, phonetic symbols of this word, and model speech data are stored as important-word-for-practice data and speech data of the important-word-for-practice data. Words with shorter word lengths than the words, which are the objects of learning and are stored in the above-described word database 32b, are chosen as the words which are stored in the word-for-practice search table 32d.

In the RAM 33 in the data processing device 30, display data storage area 33a, a word-for-practice/illustrative sentence data storage area 33b, a recorded speech data storage area 33c and an evaluation score data storage area 33d are secured.

The display data storage area 33a stores display data that is to be displayed on the touch panel-equipped display 22 of the input/output device 20, the display data being generated in accordance with the execution of the control programs 32a by the controller 31.

The word-for-practice/illustrative sentence data storage area 33b stores data of a word or data of an illustrative sentence, which was selected and read out by the user from the word database 32b or illustrative sentence database 32c in a pronunciation practice process which is executed in accordance with the pronunciation learning support program of the control programs 32a, or stores data of an important word for practice which was searched and read out from the word-for-practice search table 32d.

In the recorded speech data storage area 33c, speech data, which was uttered by the user and was input from the speech input/output unit 23, is recorded and stored, with respect to the word or illustrative sentence, or important word for practice, which was stored in the word-for-practice/illustrative sentence data storage area 33b.

The evaluation score data storage area 33d stores data of evaluation scores for respective phonetic symbols and average scores of the evaluation scores. The evaluation scores are obtained in accordance with the degree of similarity by comparison between the speech data by the user's pronunciation, which is stored in the recorded speech data storage area 33c, and the model speech data of the corresponding word or illustrative sentence, or the important word for practice, which is stored in the word database 32b or illustrative sentence database 32c, or the word-for-practice search table 32d.

In the pronunciation learning support apparatus 10 with the above configuration, the controller (CPU) 31 of the data processing device 30 controls the operations of the respective circuit components in accordance with instructions described in the control programs 32a (including the dictionary search program and the pronunciation learning support program), and realizes functions which will be described later in the description of operations, by the cooperative operation of software and hardware.

Next, the operation of the pronunciation learning support apparatus 10 with the above configuration is described.

### First Embodiment

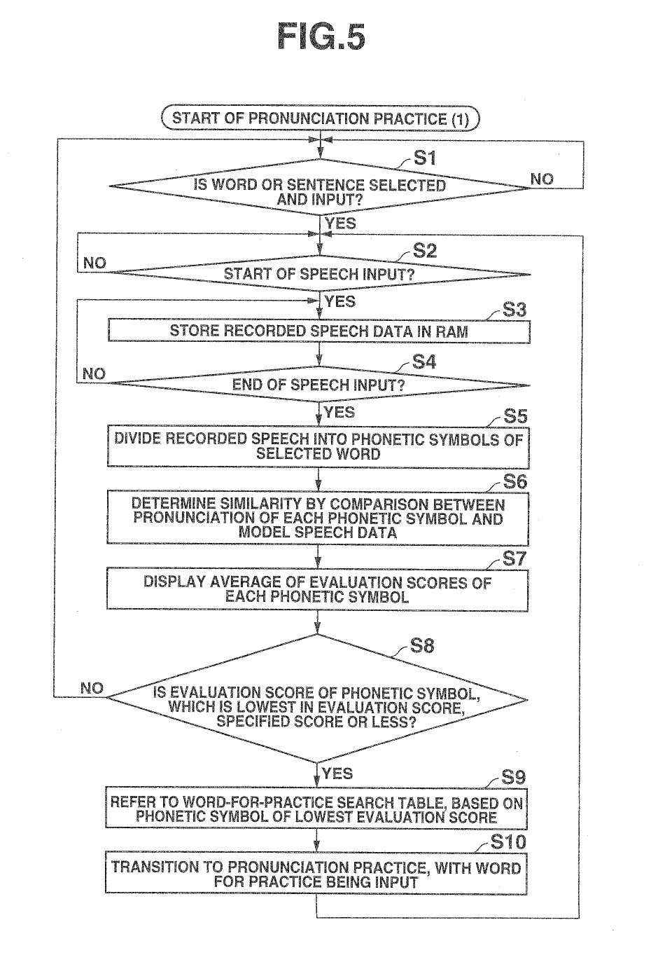

FIG. 5 is a flowchart illustrating a pronunciation practice process (1) of the first embodiment by the pronunciation learning support apparatus 10.

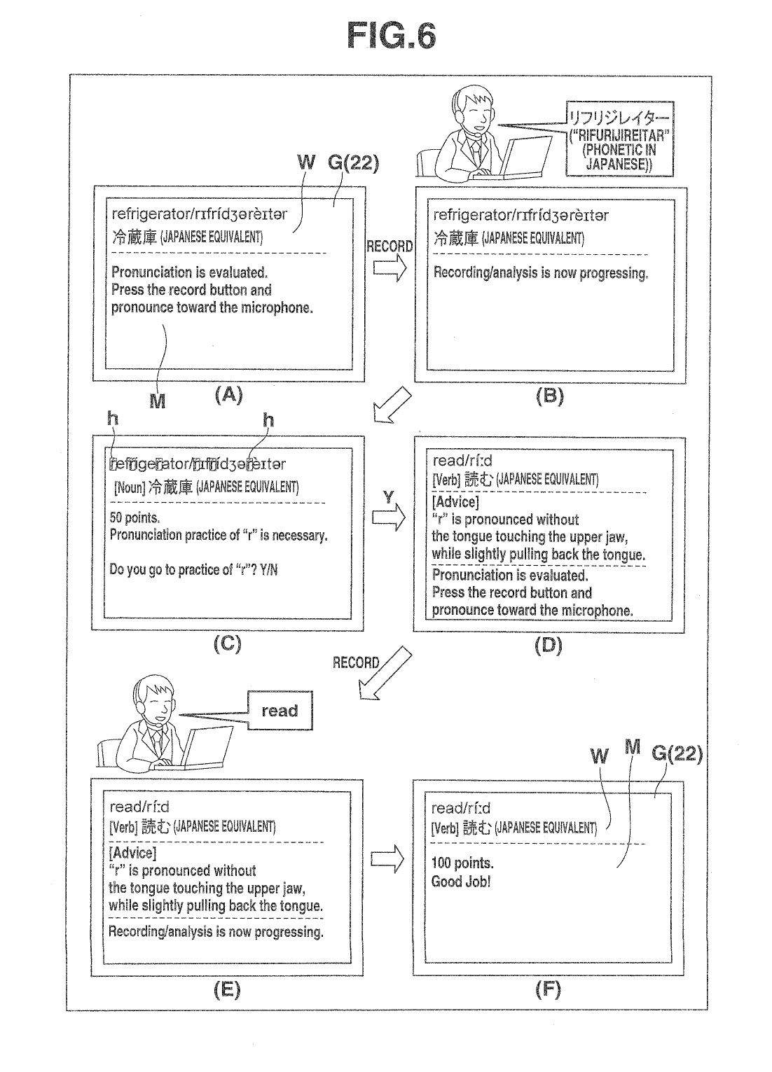

FIG. 6 is a view illustrating a display operation corresponding to a user operation according to the pronunciation practice process (1) of the first embodiment of the pronunciation learning support apparatus 10.

If an application of the control program 32a (pronunciation learning support program) is started by the data processing device 30 in accordance with a user operation of the input/output device 20, the pronunciation practice process (1) in FIG. 5 is started. Then, a learning object select menu (not shown) is generated for prompting the user to select a word or an illustrative sentence of the object of learning from the respective words or illustrative sentences stored in the word database 32b, an illustrative sentence database 32c, and the learning object select menu is displayed on the touch panel-equipped display 22.

If it is determined by the controller 31 of the data processing device 30 that a word or an illustrative sentence was selected in accordance with a user operation on the learning object select menu (step S1 (Yes)), a pronunciation practice screen G, as illustrated in, for example, part (A) of FIG. 6, is generated, output to the input/output device 20, and displayed on the touch panel-equipped display 22. In the pronunciation practice screen G, the text of the selected word “refrigerator”, the phonetic symbols and the translation equivalent “ [symbol] ” are written in a word-for-practice/illustrative sentence area W. In addition, in the pronunciation practice screen G, a message prompting the user to pronounce the word, “Pronunciation is evaluated. Press the record button and pronounce toward the microphone.”, is written in a message area M.

Then, the controller 31 of the data processing device 30 enters a standby state until detecting the input of user speech from the speech input/output unit 23 of the input/output device 20 (step S2).

Then, for example, if a [Record] button, which is provided on the key input unit 21 of the input/output device 20 is operated by the user, and it is determined that a speech input of “ [symbol] ” (phonetic in Japanese) was started from the user (step S2 (Yes)), the input speech data is stored in the recorded speech data storage area 33c in the RAM 33 until the speech input ends (step S3, S4).

At this time, as illustrated in part (B) of FIG. 6, a pronunciation practice screen G, in which a message notifying the user that recording/analysis is now progressing, is written in the message area M, is generated, output to the input/output device 20, and displayed on the touch panel-equipped display 22 of the input/output device 20.

Then, if the end of the speech input by the user is determined (step S4 (Yes)), the speech data of the user, which was stored in the recorded speech data storage area 33c, is divided into phonetic symbols of the word “refrigerator”, “ri”, “f”, “i”, “dge”, “re”, “i”, “ter” (in the case of a consonant phonetic symbol, a phonetic symbol string including a subsequent vowel) (step S5). Incidentally, for the purpose of convenience of character input, phonetic symbols described in the present specification are expressed by using ordinary lowercase letters of the alphabet.

The speech data of each divided phonetic symbol is compared with the model speech data of the word, which is stored in the word database 32b, and the degree of similarity therebetween is calculated. An evaluation score corresponding to the degree of similarity is acquired and stored in the above-described evaluation score data storage area 33d (step S6).

In addition, the average score of the evaluation scores for the user's speech data of the respective phonetic symbols of the word is calculated. For example, as illustrated in part (C) of FIG. 6, a pronunciation practice screen G, in which the average evaluation score “50 points” is written in the message area M, is generated and displayed (step S7).

Then, with respect to the phonetic symbol of the lowest evaluation score of the evaluation scores of the respective phonetic symbols, which are stored in the evaluation score data storage area 33d, it is determined whether this lowest evaluation score is a specified score (e.g. 70 points) or less (step S8).

Here, if it is determined that the evaluation score of the user speech “ [symbol] ” (phonetic symbol “ri”) relating to “r” of the word “refrigerator” is the specified value or less (step S8 (Yes)), a speech practice screen G, as illustrated in part (C) of FIG. 6, is generated and displayed. In this speech practice screen G, a message notifying the user of a pronunciation part which the user is not good at, and prompting the user to practice this pronunciation part, that is, “Pronunciation practice of ‘r’ is necessary. Do you go to practice of ‘r’? Y/N”, is written in the message area M. At this time, of the text of the word “refrigerator”, a character “r” corresponding to the pronunciation part, which the user is not good at, is distinguishably displayed (h) by reverse video.

Then, if the [Y (Select)] key of the key input section 21 is input, an important word for practice “read”, which has a short word length and with which the phonetic symbol “ri” that was determined to have the evaluation score of the specified score or less is associated as the phonetic symbol which the user is not good at, is searched and read out from the word-for-practice search table 32d (see FIG. 4) (step S9).

Then, the important word for practice “read”, which has the pronunciation of the phonetic symbol “ri” that the user is not good at, is newly stored in the word-for-practice/illustrative sentence data storage area 33b, and a transition occurs to the pronunciation practice process of the above-described step S2 onwards (step S10).

Specifically, a pronunciation practice screen G, as illustrated in part (D) of FIG. 6, is generated and displayed. In this pronunciation practice screen G, the text of the important word for practice “read”, phonetic symbols “ri:d” and the translation equivalent “ [symbol] ” are written in the word-for-practice/illustrative sentence area W. In addition, in the pronunciation practice screen G, advice on pronunciation, “r′ is pronounced without the tongue touching the upper jaw, while slightly pulling back the tongue”, and a message prompting the user to pronounce the word, “Pronunciation is evaluated. Press the record button and pronounce toward the microphone.”, is written in the message area M.

In addition, if the speech data uttered by the user is stored in the recorded speech data storage area 33c in accordance with the pronunciation practice screen G of the important word for practice “read”, which was generated and displayed as illustrated in part (E) of FIG. 6, like part (A) of FIG. 6 (steps S2 to S4), the user's speech data is analyzed on a phonetic-symbol-by-phonetic-symbol basis and the similarity to the model speech data is calculated in the same manner as described above (step S5, S6). Then, as illustrated in part (F) of FIG. 6, a pronunciation practice screen G, in which the average evaluation score and an associated message, “100 points. Good Job!”, are written in the message area M, is generated and displayed (step S7).

Here, since it is determined that the score of the phonetic symbol with the lowest evaluation score is not the specified core or less (step S8 (No)), the process returns to the beginning of the series of process steps of the pronunciation practice process (1). A learning object select menu (not shown) for prompting the user to select a word or an illustrative sentence of the next object of learning is generated and displayed.

Thus, even when a word or an illustrative sentence, which was selected as the object of learning, is a word or an illustrative sentence of long text, there is no need to repeat the pronunciation practice of the entire text. Pronunciation practice can be performed with a shorter, important word for practice that is chosen as a special word for practice of a pronunciation part that the user is not good at, and more efficient and effective practice of the pronunciation of the word becomes possible.

### Second Embodiment

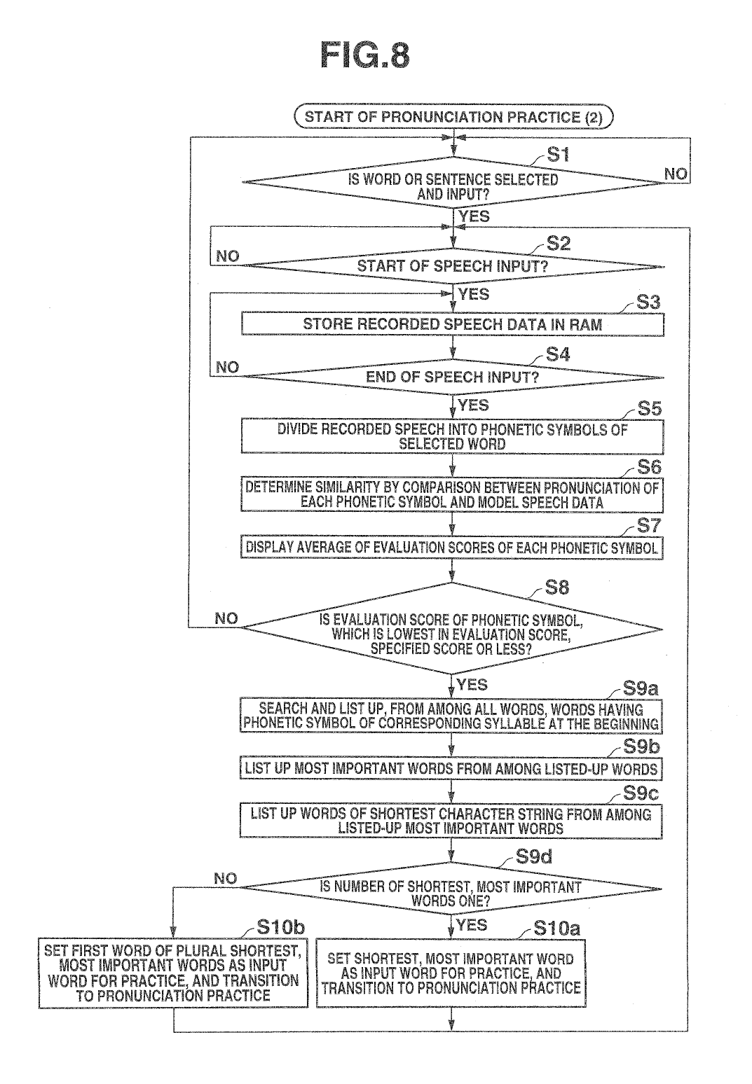

FIG. 8 is a flowchart illustrating a pronunciation practice process (2) of a second embodiment by the pronunciation learning support apparatus 10.

In the pronunciation practice process (2) of the second embodiment, the same process steps as in the pronunciation practice process (1) of the first embodiment, which is illustrated in FIG. 5, are denoted by the same step signs, and a detailed description thereof is omitted.

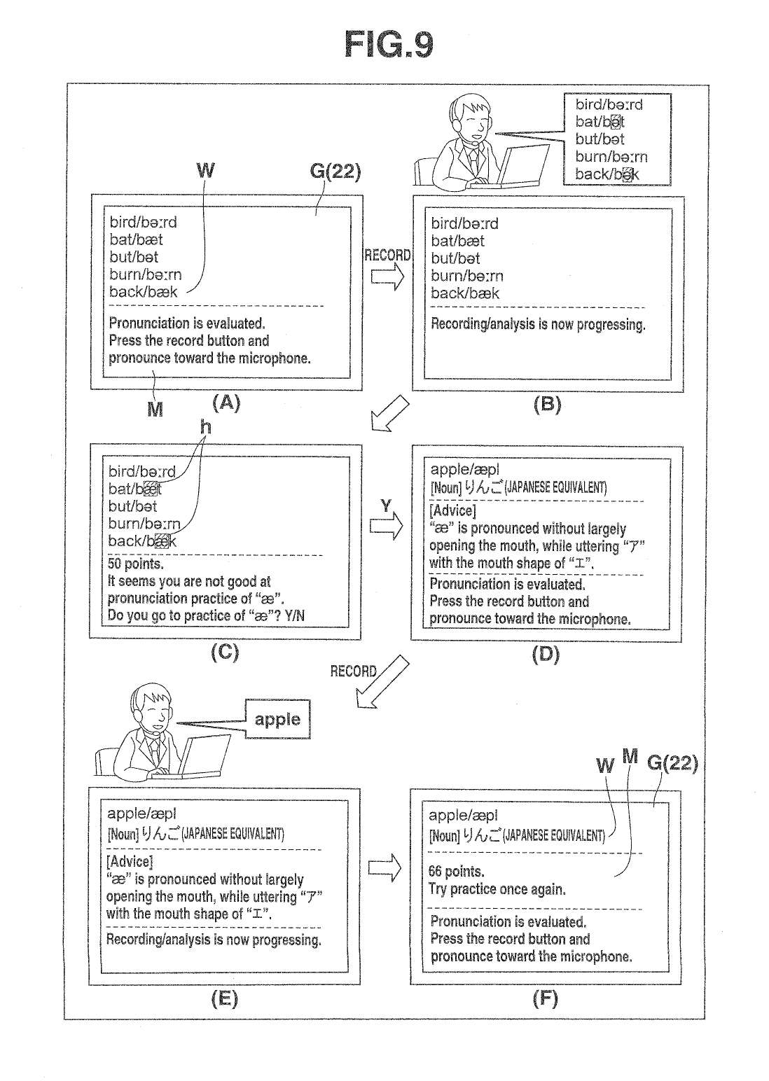

FIG. 9 is a view illustrating a display operation corresponding to a user operation according to the pronunciation practice process (2) of the second embodiment of the pronunciation learning support apparatus 10.

In the second embodiment, a description is given of an operation in a case in which a plurality of words “bird”, “bat”, “but”, “burn” and “back” were selected in accordance with a user operation on the learning object select menu displayed on the touch panel-equipped display 22 of the input/output device 20.

If it is determined by the controller 31 of the data processing device 30 that words or illustrative sentences were selected in accordance with a user operation on the learning object select menu (step S1 (Yes)), a pronunciation practice screen G, as illustrated in, for example, part (A) of FIG. 9, is generated, output to the input/output device 20, and displayed on the touch panel-equipped display 22. In the pronunciation practice screen G, the text of the plural selected words “bird”, “bat”, “but”, “burn” and “back”, and the phonetic symbols are written in the word-for-practice/illustrative sentence area W. In addition, in the pronunciation practice screen G, a message prompting the user to pronounce the words, “Pronunciation is evaluated. Press the record button and pronounce toward the microphone.”, is written in the message area M.

Then, like the first embodiment, as illustrated in part (B) of FIG. 9, with respect to the pronunciations of the plural selected words that are the objects of learning, the user's speech data is input from the speech input/output unit 23 of the input/output device 20 and is stored in the recorded speech data storage area 33c of the data processing device 30 (steps S2 to S4). The user's speech data is divided in units of a phonetic symbol with respect to all the words (step S5), and the degree of similarity is calculated by comparison between the speech data of each divided phonetic symbol and the corresponding model speech data (step S6).

In addition, the average score of the evaluation scores, which were acquired in accordance with the degree of similarity of speech of each phonetic symbol, is calculated. For example, as illustrated in part (C) of FIG. 9, the average score is displayed as “50 points” (step S7).

Here, if it is determined that the lowest evaluation score of the evaluation scores of pronunciations of the respective phonetic symbols is the specified value or less (step S8 (Yes)), the phonetic symbol “æ” of the pronunciation part, which was determined to be the specified value or less, is distinguishably displayed (h) by reverse video.

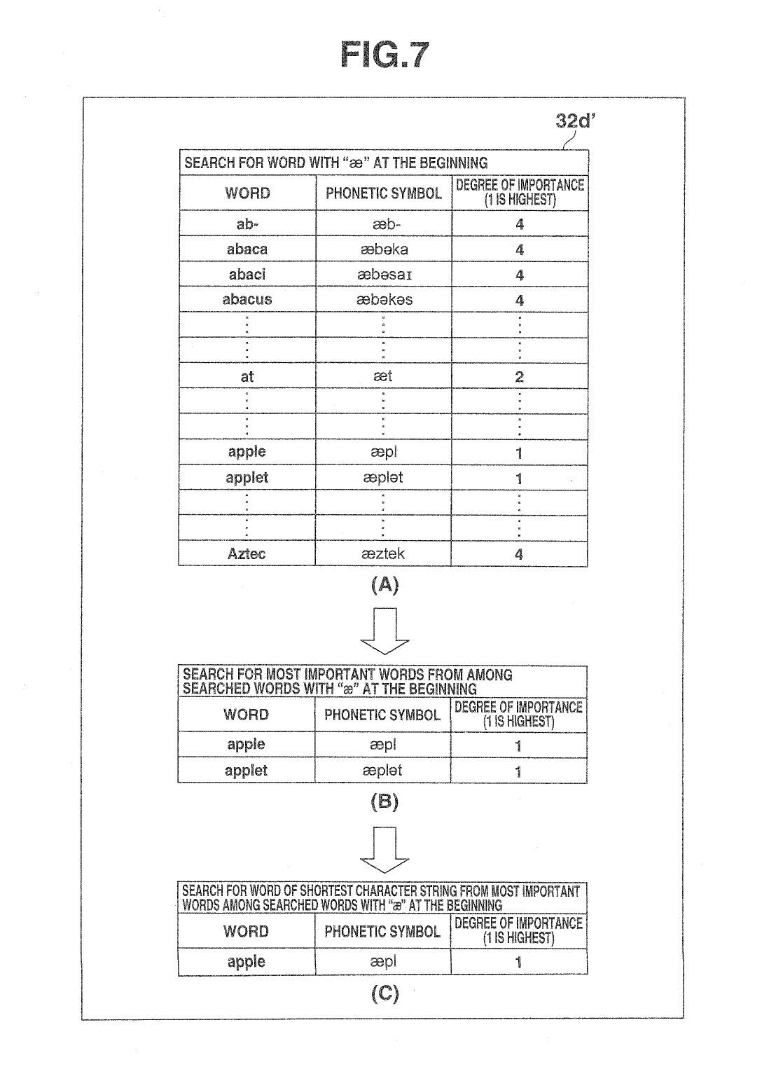

Then, words each having, at the beginning, the phonetic symbol of the pronunciation, the evaluation score of which was determined to be the specified value or less, are extracted from the dictionary database and stored in a word-for-practice search table 32d′ (step S9a). Here, the phonetic symbol “æ” is regarded as the phonetic symbol which the user is not good at, arid words “ab-”, “abaca”, “abaci”, . . . , each having the phonetic symbol “æ” at the beginning, are stored in the word-for-practice search table 32d′, as illustrated in part (A) of FIG. 7. Incidentally, it is assumed that the degree of importance of learning is associated with each word. Next, the extracted words are narrowed down to words with a high degree of importance (step S9b). In this case, as illustrated in part (B) of FIG. 7, most important words “apple” and “applet”, with which the degree of importance “1” is associated, are extracted.

Then, as illustrated in part (C) of FIG. 7, the word “apple” of the shortest character string is extracted from the extracted most important words “apple” and “applet” (step S9c), and it is determined whether the number of extracted shortest, most important words is one or not (step S9d).

Here, if it is determined that the number of shortest, most important words extracted in steps S9b and S9c is one that is “apple” (step S9d (Yes)), the shortest, most important word “apple” having at the beginning the pronunciation of the phonetic symbol “æ”, which the user is not good at, is newly stored in the word-for-practice/illustrative sentence data storage area 33b as the word for practice, and a transition occurs to the pronunciation practice process of step S2 onwards (step S10a).

Specifically, a pronunciation practice screen G, as illustrated in part (D) of FIG. 9, is generated and displayed. In this pronunciation practice screen G, the text of the word for practice “apple” and phonetic symbols “æpl” are written in the word-for-practice/illustrative sentence area W. In addition, in the pronunciation practice screen G, advice on pronunciation, “‘æ’ is pronounced without largely opening the mouth, while uttering ‘ [symbol] ’ with the mouth shape of ‘ [symbol] ’ and a message prompting the user to pronounce the word, “Pronunciation is evaluated. Press the record button and pronounce toward the microphone.”, is written in the message area M.

Then, like the above, if the speech data uttered by the user is stored in the recorded speech data storage area 33c in accordance with the pronunciation practice screen G of the important word for practice “apple”, which was generated and displayed as illustrated in part (E) of FIG. 9 (steps S2 to S4), the user's speech data is analyzed on a phonetic-symbol-by-phonetic-symbol basis and the similarity to the model speech data is calculated (step S5, S6). Then, as illustrated in part (F) of FIG. 9, a pronunciation practice screen G, in which the average evaluation score “66 points” and a message prompting the user to practice the pronunciation of the word, “Try practice once again. Pronunciation is evaluated. Press the record button and pronounce toward the microphone.”, are written in the message area M, is generated and displayed (step S7).

In the meantime, in step S9d, if it is determined that the number of shortest, most important words extracted in steps S9b and S9c is not one but two or more (step S9d (No)), the first word of the plural shortest, most important words is newly stored in the word-for-practice/illustrative sentence data storage area 33b as a word for practice, and a transition occurs to the pronunciation practice process of step S2 onwards (step S10b).

Thus, according to the pronunciation practice process (2) of the second embodiment by the pronunciation learning support apparatus 10 with the above structure, there is no need to independently prepare the word-for-practice search table 32d of the first embodiment, in which words of short character strings including the pronunciation of each of various phonetic symbols are collected and recorded as important-word-for-practice data on a phonetic-symbol-by-phonetic-symbol basis. Even when a word or an illustrative sentence, which was selected as the object of learning, is a word or an illustrative sentence of long text, there is no need to repeat the pronunciation practice of the entire text. Pronunciation practice can be performed with a shorter, important word for practice that is chosen as a special word for practice of a pronunciation part which the user is not good at, and more efficient and effective practice of the pronunciation of the word becomes possible.

The methods of the respective processes by the pronunciation learning support apparatus 10 and the databases (DB), which have been described in each of the embodiments, that is, the respective methods of the pronunciation practice process (1) of the first embodiment illustrated in the flowchart of FIG. 5 and the pronunciation practice process (2) of the second embodiment illustrated in the flowchart of FIG. 8, and the respective DBs, such as the word DB 32b, illustrative sentence DB 32c and word-for-practice search table 32d, can all be stored as computer-executable programs in a medium of an external storage device, such as a memory card (ROM card, RAM card, etc.), a magnetic disk (floppy disk, hard disk, etc.), an optical disc (CD-ROM, DVD, etc.), or a semiconductor memory, and can be distributed. In addition, the computer (controller) of the electronic apparatus reads the program, which is stored in the medium of the external storage device, into the storage device, and the operation is controlled by this read-in program. Thereby, it is possible to realize the pronunciation learning support function, which has been described in each of the embodiments, and to execute the same processes by the above-described methods.

In addition, the data of the program for realizing each of the above-described methods can be transmitted on a communication network in the form of a program code, and the data of the program can be taken in the electronic device from a computer apparatus (program server) connected to this communication network, and stored in the storage device, thereby realizing the above-described pronunciation learning support function.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a display; and
a processor,
the processor being configured to execute a process of:
displaying on the display a word which a user is prompted to pronounce;
acquiring voice which the user uttered the displayed word; and
analyzing a pronunciation of the acquired voice, determining a part of the word, with respect to which a pronunciation relating to the word is incorrect, acquiring, as a practice word for practice, a word which includes the part of the incorrect pronunciation and is shorter than the displayed word, and displaying on the display the practice word.

2. The electronic apparatus of claim 1, wherein the processor is configured to further execute a process of:
calculating an evaluation value by analyzing the pronunciation of the user, and determining a pronunciation part with respect to which the evaluation value is a predetermined value or less; and
acquiring a word for practice including a phonetic symbol of the pronunciation part with respect to which the evaluation value was determined to be the predetermined value or less.

3. The electronic apparatus of claim 2, further comprising word-for-practice storage for storing words for practice and pronunciations of the words for practice such that the words for practice and the pronunciations of the words for practice are mutually associated,
wherein the processor is configured to further execute a process of:
acquiring, from among the words for practice stored by the word-for-practice storage, a word which includes the pronunciation part with respect to which the evaluation value was determined to be the predetermined value or less by the determining of the pronunciation part, and which has a shorter word length than the displayed word.

4. The electronic apparatus of claim 2, further comprising dictionary storage for storing a plurality of words and pronunciations of the words such that the plurality of words and the pronunciations of the words are mutually associated,
wherein the processor is configured to execute a process of:
selecting the word which the user is prompted to pronounce, from among the plurality of words stored by the dictionary storage, in accordance with a user operation;
calculating an evaluation value by analyzing a pronunciation of the user of the selected word, by comparison between the pronunciation of the user of the selected word and a pronunciation of the word stored by the dictionary storage, and determining a pronunciation part with respect to which the evaluation value is a predetermined value or less; and
extracting, from among the plurality of words stored by the dictionary storage, a word having, at a beginning thereof, the pronunciation part determined by the determining of the pronunciation part, and acquiring, from among the extracted words, a short word as a word for practice.

5. The electronic apparatus of claim 2, wherein the processor is configured to execute a process of:
analyzing, in the determining of the pronunciation part, the pronunciation of the user of the displayed word with respect to each of phonetic symbols of the word, calculating an evaluation value with respect to each phonetic symbol, and determining a pronunciation part corresponding to a phonetic symbol with respect to which the evaluation value is a predetermined value or less.

6. The electronic apparatus of claim 1, wherein the word, which is an object of learning, is an English word.

7. A pronunciation learning support method using an electronic apparatus, comprising the steps of:
displaying a word which a user is prompted to pronounce;
acquiring voice which the user uttered the displayed word; and
analyzing a pronunciation of the acquired voice, determining a part of the word, with respect to which a pronunciation relating to the word is incorrect, acquiring, as a practice word for practice, a word which includes the part of the incorrect pronunciation and is shorter than the displayed word, and displaying on a display the practice word.

8. The pronunciation learning support method of claim 7, wherein the pronunciation practice step includes:
a pronunciation part determination step of calculating an evaluation value by analyzing the pronunciation of the user, and determining a pronunciation part with respect to which the evaluation value is a predetermined value or less; and
a word-for-practice acquisition step of acquiring a word for practice including a phonetic symbol of the pronunciation part with respect to which the evaluation value was determined to be the predetermined value or less by the pronunciation part determination step.

9. The pronunciation learning support method of claim 8, wherein the electronic apparatus includes word-for-practice storage for storing words for practice and pronunciations of the words for practice such that the words for practice and the pronunciations of the words for practice are mutually associated,
wherein the word-for-practice acquisition step includes acquiring, from among the words for practice stored by the word-for-practice storage, a word which includes the pronunciation part with respect to which the evaluation value was determined to be the predetermined value or less by the pronunciation part determination step, and which has a shorter word length than the displayed word.

10. The pronunciation learning support method of claim 8, wherein the electronic apparatus includes dictionary storage for storing a plurality of words and pronunciations of the words such that the plurality of words and the pronunciations of the words are mutually associated,
wherein the word display step includes selecting the word which the user is prompted to pronounce, from among
the plurality of words stored by the dictionary storage means, in accordance with a user operation, the pronunciation part determination step includes calculating an evaluation value by analyzing a pronunciation of the user of the selected word, by comparison between the pronunciation of the user of the selected word and a pronunciation of the word stored by the dictionary storage, and determining a pronunciation part with respect to which the evaluation value is a predetermined value or less, and
the word-for-practice acquisition step includes extracting, from among the plurality of words stored by the dictionary storage, a word having, at a beginning thereof, the pronunciation part determined by the pronunciation part determination step, and acquiring, from among the extracted words, a short word as a word for practice.

11. The pronunciation learning support method of claim 8, wherein the pronunciation part determination step includes analyzing the pronunciation of the user of the word displayed by the word display step with respect to each of phonetic symbols of the word, calculating an evaluation value with respect to each phonetic symbol, and determining a pronunciation part corresponding to a phonetic symbol with respect to which the evaluation value is a predetermined value or less.

12. The pronunciation learning support method of claim 7, wherein the word, which is an object of learning, is an English word.

13. A non-transitory computer readable storage medium having stored therein a program for controlling a computer of an electronic apparatus including a display to execute a process of:
displaying on the display a word which a user is prompted to pronounce;
acquiring voice which the user uttered the displayed word; and
analyzing a pronunciation of the acquired voice, determining a part of the word, with respect to which a pronunciation relating to the word is incorrect, acquiring, as a practice word for practice, a word which includes the part of the incorrect pronunciation and is shorter than the displayed word, and displaying on the display the practice word.

14. The storage medium of claim 13, wherein the program further controls the computer to execute a process of:
calculating an evaluation value by analyzing the pronunciation of the user, and determining a pronunciation part with respect to which the evaluation value is a predetermined value or less; and
acquiring a word for practice including a phonetic symbol of the pronunciation part with respect to which the evaluation value was determined to be the predetermined value or less.

15. The storage medium of claim 14, wherein the electronic apparatus includes word-for-practice storage means for storing words for practice and pronunciations of the words for practice such that the words for practice and the pronunciations of the words for practice are mutually associated, and
the program further controls the computer to execute a process of:
acquiring, from among the words for practice stored by the word-for-practice storage means, a word which includes the pronunciation part with respect to which the evaluation value was determined to be the predetermined value or less by the determining of the pronunciation part, and which has a shorter word length than the displayed word.

16. The storage medium of claim 14, wherein the electronic apparatus includes dictionary storage means for storing a plurality of words and pronunciations of the words such that the plurality of words and the pronunciations of the words are mutually associated, and
the program further controls the computer to execute a process of:
selecting and setting the word which the user is prompted to pronounce, from among the plurality of words stored by the dictionary storage means, in accordance with a user operation;
calculating an evaluation value by analyzing a pronunciation of the user of the set word, by comparison between the pronunciation of the user of the set word and a pronunciation of the word stored by the dictionary storage means, and determining a pronunciation part with respect to which the evaluation value is a predetermined value or less; and
extracting, from among the plurality of words stored by the dictionary storage means, a word having, at a beginning thereof, the pronunciation part determined by the determining of the pronunciation part, and acquiring, from among the extracted words, a short word as a word for practice.

17. The storage medium of claim 14, wherein the program further controls the computer to execute a process of:
analyzing, in the determining of the pronunciation part, the pronunciation of the user of the word displayed by the displaying of the word, with respect to each of phonetic symbols of the word, calculating an evaluation value with respect to each phonetic symbol, and determining a pronunciation part corresponding to a phonetic symbol with respect to which the evaluation value is a predetermined value or less.

18. The storage medium of claim 13, wherein the word, which is an object of learning, is an English word.
